(19) United States
(12) Patent Application Publication
(10) Pub. No.: US 2025/0360441 A1
(43) Pub. Date: Nov. 27, 2025

(54) Filter Device for Cutting Fluid, Cleaning Method for Filter Device, and Filter Circulation System

(71) Applicant: QINGDAO GAOCE TECHNOLOGY CO., LTD., Qingdao, Shandong (CN)

(72) Inventors: Yangang YIN, Qingdao, Shandong (CN); Lu ZHANG, Qingdao, Shandong (CN); Junke TANG, Qingdao, Shandong (CN); Xinkai ZHANG, Qingdao, Shandong (CN)

(21) Appl. No.: 18/867,779

(22) PCT Filed: May 20, 2023
(86) PCT No.: PCT/CN2023/095412

§ 371 Date: Nov. 20, 2024

(30) Foreign Application Priority Data
May 20, 2022 (CN) 202210552551.3
May 20, 2022 (CN) 202221215631.1
May 20, 2022 (CN) 202221217808.1
Apr. 17, 2023 (CN) 202310406925.5
Apr. 17, 2023 (CN) 202320861223.1

(51) Int. Cl. B01D 29/72; B01D 29/11; B01D 29/60; B01D 35/16; B28D 5/00; B28D 5/04

(52) U.S. Cl. CPC B01D 29/72; B01D 29/11; B01D 29/603; B01D 29/606; B01D 35/16; B28D 5/0076; B01D 2201/29; B01D 2201/347; B28D 5/0064; B28D 5/045

(57) ABSTRACT

Disclosed are a filter device for cutting fluid, a cleaning method for the filter device, and a filter circulation system. The filter device includes a filter cartridge, a filter screen and an ultrasonic cleaning assembly, where the filter screen is disposed in the filter cartridge, and the filter screen is provided with a cutting fluid inlet and a drain outlet. The cutting fluid inlet is configured to allow to-be-filtered cutting fluid to flow into. The drain outlet is configured to discharge cleaning liquid and sewage in the filter screen. The filter cartridge is provided with a cutting fluid outlet, and the cutting fluid outlet is configured to discharge cutting fluid filtered.

### CROSS-REFERENCE TO RELATED APPLICATION

The disclosure claims priorities to the Chinese patent applications CN202210552551.3 filed on May 20, 2022 and entitled “Automatic Cleaning Method for Cutting Fluid Circulation System of Wire Cutting Machine”, CN202221215631.1 filed on May 20, 2022 and entitled “Cutting Fluid Circulation System and Wire Cutting Machine”, CN202221217808.1 filed on May 20, 2022 and entitled “Filter Device for Filter Cutting Fluid of Cutting Machine”, CN202310406925.5 filed on Apr. 17, 2023 and entitled “Filter Device for Cutting Fluid of Wire Cutting Machine and Cleaning Control Method therefor”, and CN202320861223.1 filed on Apr. 17, 2023 and entitled “Filter Device for Cutting Fluid of Wire Cutting Machine”, which are incorporated in their entireties herein by reference.

### TECHNICAL FIELD

The disclosure relates to the technical field of wire cutting, and specifically relates to a filter device for cutting fluid, a cleaning method for the filter device, and a filter circulation system.

### BACKGROUND

When a wire cutting apparatus is used for machining, quality of finished workpieces will be affected by cleanliness of cutting fluid. Thus, a filter device for filter cutting fluid is disposed in a circulation system for the cutting fluid, so as to improve cleanliness of the cutting fluid. However, after the filter device is used for a certain period, a filter screen of the filter device is prone to blockage, resulting in a poorer filter effect and a smaller flow amount of the cutting fluid.

At present, the filter screen in the filter device is generally disassembled, cleaned or replaced manually. In this case, cleaning efficiency is low, which influences machining efficiency of the wire cutting apparatus. Moreover, an effect of manual cleaning is uncertain, leading to low reliability.

### SUMMARY

Embodiments of the disclosure provide a filter device for cutting fluid, a cleaning method for the filter device, and a filter circulation system, so as to solve problems of low cleaning efficiency, low reliability and influence on machining efficiency of a wire cutting apparatus caused by the fact that a filter screen of the filter device for cutting fluid needs to be manually cleaned or replaced.

Some embodiments of the disclosure provide a filter device for cutting fluid. The filter device includes:
a filter cartridge and a filter screen, where the filter screen is disposed in the filter cartridge, the filter screen is provided with a cutting fluid inlet and a drain outlet, the cutting fluid inlet is configured to allow to-be-filtered cutting fluid to flow into, the drain outlet is configured to discharge cleaning liquid and sewage in the filter screen, the filter cartridge is provided with a cutting fluid outlet, and the cutting fluid outlet is configured to discharge cutting fluid filtered; and
an ultrasonic cleaning assembly, where at least part of the ultrasonic cleaning assembly is disposed in the filter screen and configured to conduct ultrasonic cleaning on the filter screen.

Some embodiments of the disclosure provide a filter circulation system for cutting fluid. The filter circulation system includes:
a spraying device configured to spray the cutting fluid onto a workpiece cutting zone;
a liquid supply device configured to accommodate the cutting fluid and provide power for circulation of the cutting fluid;
a collecting device disposed on the liquid supply device and configured to collect the cutting fluid left after workpiece spraying and convey the cutting fluid to the liquid supply device;
a filter device connected between the spraying device and the liquid supply device and configured to filter the cutting fluid, where the filter device is the filter device mentioned above; and
a heat exchange device connected between the filter device and the spraying device and configured to cool the cutting fluid.

Some embodiments of the disclosure provide a cleaning method for a filter device for cutting fluid. The filter device includes a filter cartridge, a filter screen and an ultrasonic cleaning assembly. The filter screen is disposed in the filter cartridge. At least part of the ultrasonic cleaning assembly is disposed in the filter screen and configured to conduct ultrasonic cleaning on the filter screen.

The cleaning method includes:
determining whether a wire cutting machine is in a cutting operation state; and
cleaning, in response to determining that the wire cutting machine is in the cutting operation state, the filter screen by the ultrasonic cleaning assembly.

### BRIEF DESCRIPTION OF THE DRAWINGS

In order to more clearly describe technical solutions of embodiments of the disclosure, the accompanying drawings required in the embodiments of the disclosure will be introduced briefly below. It should be understood that the following accompanying drawings illustrate only some embodiments of the disclosure and therefore should not be construed as a limitation on its scope. For those of ordinary skill in the art, other relevant accompanying drawings can also be obtained from these accompanying drawings without any creative effort.

FIG. 1 is a schematic structural diagram of a filter circulation system for cutting fluid according to some embodiments of the disclosure;

FIG. 2 is a schematic structural diagram of a cutaway view of a filter device for cutting fluid according to some embodiments of the disclosure;

FIG. 3 is a schematic enlarged diagram of a partial structure of a filter device for cutting fluid according to some embodiments of the disclosure;

FIG. 4 is a schematic structural diagram of a cutaway view of a filter device for cutting fluid according to some other embodiments of the disclosure;

FIG. 5 is a schematic structural diagram of a cutaway view of a filter device for cutting fluid according to some other embodiments of the disclosure;

FIG. 6 is a schematic structural diagram of a cutaway view of a filter device for cutting fluid according to some other embodiments of the disclosure;

FIG. 7 is a schematic structural diagram of a cutaway view of a filter device for cutting fluid according to some other embodiments of the disclosure;

FIG. 8 is a schematic structural diagram of a cutaway view of a filter device for cutting fluid according to some other embodiments of the disclosure;

FIG. 9 is a schematic structural diagram of a filter circulation system for cutting fluid according to some other embodiments of the disclosure;

FIG. 10 is a schematic structural diagram of a wire cutting machine according to some other embodiments of the disclosure;

FIG. 11 is a schematic structural diagram of a filter device according to some other embodiments of the disclosure;

FIG. 12 is a schematic structural diagram of a cutaway view of a filter device according to some other embodiments of the disclosure;

FIG. 13 is a schematic diagram of a partial structure of a filter device according to some other embodiments of the disclosure;

FIG. 14 is a schematic structural diagram of a filter device according to some other embodiments of the disclosure;

FIG. 15 is a schematic diagram of a partial structure of a filter device according to some other embodiments of the disclosure;

FIG. 16 is a schematic diagram of a partial structure of a filter device according to some other embodiments of the disclosure;

FIG. 17 is a schematic diagram of a partial structure of a filter device according to some other embodiments of the disclosure;

FIG. 18 is a schematic diagram of a partial structure of a filter device according to some other embodiments of the disclosure;

FIG. 19 is a schematic flow diagram of a method for cleaning a filter device for cutting fluid according to some embodiments of the disclosure; and

FIG. 20 is a schematic flow diagram of a method for cleaning a filter device for cutting fluid according to some embodiments of the disclosure.

1, Filter cartridge; 2, filter screen, 3, ultrasonic cleaning assembly; 4, pressure measurement assembly; 5, filter cartridge connector; 11, filter cartridge body; 12, cartridge cover; 13, sealing ring; 14, fixing ring; 15, fixing mounting plate; 16, mounting ring wall; 17, sealing ring; 18, cutting fluid inlet; 21, flange; 22, conical part; 23, mounting column; 6, cutting fluid drain pipe; 61, cutting fluid drain control valve; 62, drain outlet; 7, cleaning liquid inlet pipe; 8, cutting fluid output pipe; 81, cutting fluid output control valve; 82, cutting fluid outlet; 9, compression ring; 10, liquid supply device; 20, spraying device; 30, heat exchange device; 40, flowmeter; 50, filter device; 70, pressure measurement assembly; 80, collecting device; 120, ultrasonic washing assembly; cutting fluid outlet; 52, drain outlet; 54, cartridge cover; 55, cartridge body; 56, filter screen; 57, cutting fluid inlet; 515, boss; 90, cutting fluid input pipe; 91, cutting fluid output pipe; 92, drain pipe; 121, ultrasonic transducer; 122, ultrasonic amplitude transformer; 123, sealing pressure plate; 124, ultrasonic vibrating rod; 125, ultrasonic vibrator; 126, cleaning liquid inlet pipe; 1241, flange part; 300, cutting fluid outlet valve; 400, drain valve; 900, cleaning control valve; 1001, electric control cabinet; 1002, liquid path system; 1003, winding chamber assembly; 1004, winding chamber shield assembly; 1005, spindle assembly; 1006, lathe bed assembly; 1007, four-column feeding and swinging mechanism; 1008, cutting zone assembly; 1009, cutting zone shield assembly.

### DETAILED DESCRIPTION OF THE EMBODIMENTS

In order to make objectives, technical solutions and advantages of embodiments of the disclosure clearer, the technical solutions of the embodiments of the disclosure will be described clearly and completely below with reference to the accompanying drawings in the embodiments of the disclosure. Obviously, the embodiments described are some embodiments rather than all embodiments of the disclosure. On the basis of the embodiments of the disclosure, all other embodiments obtained by those of ordinary skill in the art without making creative efforts fall within the protection scope of the disclosure.

Unless otherwise defined, all technical and scientific terms used in the disclosure have the same meanings as those commonly understood by those skilled in the technical field of the disclosure. In the disclosure, the terms used in the description of the disclosure are merely for the purpose of describing specific embodiments, and are not intended to limit the disclosure. The terms “include” and “have” and any variations thereof in the description and claims of the disclosure and the above accompanying drawings are intended to cover non-exclusive inclusions.

The terms “first”, “second”, etc. in the description and claims of the disclosure or the accompanying drawings are used to distinguish different objects, instead of describing a specific order or a primary and secondary relation.

In the disclosure, the phrase “example” mentioned in the disclosure means that specific features, structures, or characteristics described with reference to the embodiments can be encompassed in at least one example of the disclosure. The phrase at various positions in the description does not necessarily indicate the same example, or an independent or alternative example exclusive of another example.

In the description of the disclosure, it should be noted that, unless expressly specified and defined otherwise, the terms “mount”, “connect”, “connected” and “attach” are to be construed broadly. For instance, they can denote fixed connection, detachable connection or integral connection, denote direct connection or indirect connection by means of an intermediate medium, or denote communication between interiors of two elements. For those of ordinary skill in the art, specific meanings of the above terms in the disclosure can be understood according to specific circumstances.

The term “a plurality of” in the disclosure means two or more.

With advantages of wide application range, high precision, burr-free finished products, consumables difficult to damage and low cost, a wire cutting machine is a cutting apparatus widely used at present. As a wire cutting technology is developed, requirements for machining quality and efficiency of a wire cutting apparatus become increasingly higher.

When the wire cutting apparatus is used for machining, and especially, cutting hard and brittle materials into sections, blocks and slices, cleanliness of cutting fluid can greatly influence quality of finished workpieces. Thus, in order to improve cleanliness of the cutting fluid, a filter device for filter cutting fluid is disposed in a circulation system for the cutting fluid. The filter device can effectively filter impurities such as thread residues and particles in the cutting fluid. However, in a process of wire cutting, and especially slicing, a lot of fine dust is generated, causing a filter screen to be gradually blocked during use of the filter device. In this case, a filter effect becomes poorer, a flow amount of the cutting fluid is reduced, and problems such as jumpers and broken wires during machining are caused. Further, quality and machining efficiency of workpieces are influenced. At present, the filter screen is manually cleaned or replaced. In this case, operation of the filter circulation system needs to be suspended when the filter screen is disassembled, leading to supply suspension of the cutting fluid and influencing machining efficiency of the wire cutting apparatus. In addition, an effect of manual cleaning is uncertain, leading to low reliability.

Based on the above considerations, some embodiments of the disclosure provide a filter device for cutting fluid, which can automatically clean a filter screen in the filter device, and achieve a desirable cleaning effect and high reliability. Moreover, the filter screen does not need to be disassembled during cleaning, and cleaning efficiency is high, which is conducive to improvement in machining efficiency of the wire cutting apparatus.

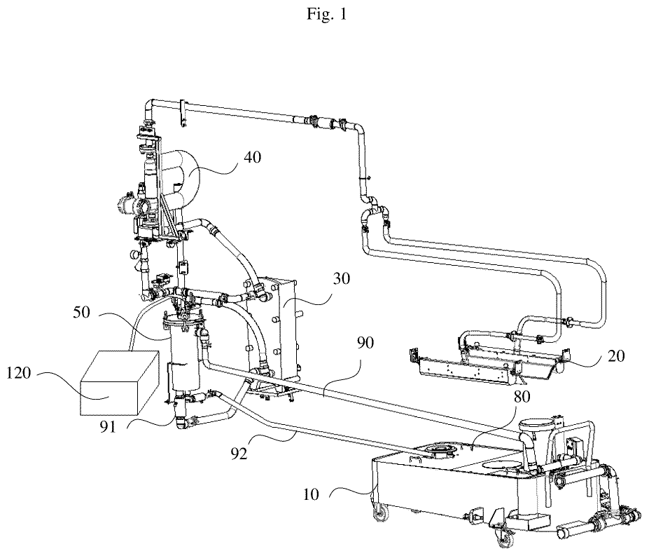

With reference to FIG. 1, FIG. 1 is a schematic structural diagram of a filter circulation system for cutting fluid according to some embodiments of the disclosure. The filter circulation system includes a liquid supply device 10, a spraying device 20, a collecting device 80 and a filter device 50. The spraying device 20 is configured to spray the cutting fluid onto a workpiece cutting zone (not shown in the figure). The liquid supply device 10 is configured to accommodate the cutting fluid and provide power for circulation of the cutting fluid. The collecting device 80 is disposed on the liquid supply device 10 and configured to collect the cutting fluid left after workpiece (not shown in the figure) spraying and convey the cutting fluid to the liquid supply device 10. The filter device 50 is connected between the spraying device 20 and the liquid supply device 10 and configured to filter the cutting fluid.

In some embodiments, the workpiece cutting zone is a zone where the wire cutting apparatus is configured to bear and cut a workpiece. The workpiece cutting zone is disposed between the spraying device 20 and the collecting device 80. In this way, the cutting fluid sprayed by the spraying device 20 falls onto the workpiece cutting zone. The workpiece cutting zone is provided with a through hole, such that the cutting fluid left after workpiece spraying flows to the collecting device 80 through the through hole.

By arranging the liquid supply device 10 and the spraying device 20, the cutting fluid can be sprayed. By arranging the collecting device 80, the cutting fluid can be recycled, which is conducive to environmental protection. By arranging the filter device 50, the used cutting fluid can be filtered, so as to improve cleanliness of the cutting fluid. Thus, influence of impurities in the recycled cutting fluid on workpiece machining is reduced, and quality of finished workpieces can be improved.

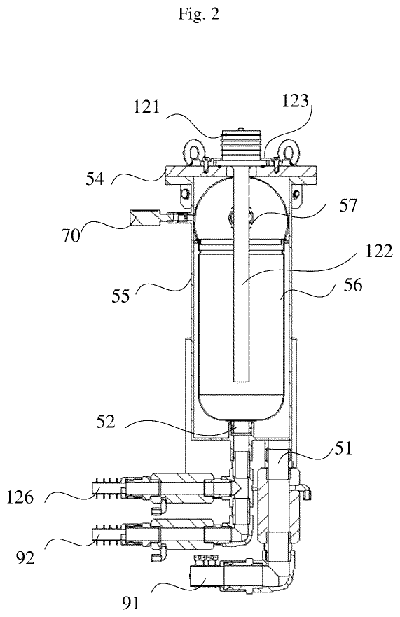

With reference to FIG. 2, FIG. 2 is a schematic structural diagram of a cutaway view of a filter device for cutting fluid according to some embodiments of the disclosure. In some embodiments, a filter device 50 includes a filter cartridge, a filter screen 56 and an ultrasonic cleaning assembly 120. The filter screen 56 is disposed in the filter cartridge. The filter screen 56 is provided with a cutting fluid inlet 57 and a drain outlet 52. The cutting fluid inlet 57 is configured to allow to-be-filtered cutting fluid to flow into. The drain outlet 52 is configured to discharge cleaning liquid and sewage in the filter screen 56. The filter cartridge is provided with a cutting fluid outlet 51. The cutting fluid outlet 51 is configured to discharge the cutting fluid filtered. At least part of the ultrasonic cleaning assembly 120 is disposed in the filter screen 56 and configured to conduct ultrasonic cleaning on the filter screen 56.

In some embodiments, the cutting fluid inlet 57 is configured to enable communication with the outside, such as a liquid supply device 10, through a cutting fluid input pipe 90, so as to allow the cutting fluid to flow into the filter screen 56 through the cutting fluid inlet 57. The filter cartridge is provided with an avoidance port (not shown in the figure) corresponding to the cutting fluid inlet 57, such that the pipe is in communication with the cutting fluid inlet 57.

In some embodiments, the drain outlet 52 is located on a bottom of the filter screen 56 and configured to enable communication with the outside, such as the liquid supply device 10, through a drain pipe 92, so as to discharge impurities and cleaning liquid in the filter screen 56. Thus, sewage left after washing, especially the large particles, cannot remain in the filter screen 56, such that a possibility of blocking the filter screen 56 can be reduced, a flow amount of the cutting fluid is within a preset range, and further a filter effect in the filter screen 56 is improved. A first sealing ring is disposed at the drain outlet 52, such that sealing performance of the drain pipe 92 can be enhanced, and a possibility of cleaning liquid leakage can be reduced.

In some embodiments, the cutting fluid outlet 51 is located on a bottom of a cartridge body 55 and configured to enable communication with the outside, such as a spraying device 20, through a cutting fluid output pipe 91, so as to allow the cutting fluid filtered to flow out to be recycled. A second sealing ring is disposed at the cutting fluid outlet 51, such that sealing performance of the cutting fluid output pipe 91 can be enhanced, and a possibility of cutting fluid leakage can be reduced.

In some embodiments, the filter cartridge is sealed, such that a possibility of foreign impurities to enter the filter cartridge can be reduced, and a possibility of cutting fluid leakage can be reduced.

In some embodiments, the filter cartridge is made of stainless steel, and is not prone to rusting and deformation, and long in service life.

In some embodiments, a mesh number of the filter screen 56 is 50 meshes-300 meshes, such that the cutting fluid can flow through the filter screen 56 quickly while impurities can be better filtered.

In some embodiments, the filter screen 56 is cylindrical, such that the cutting fluid can be filtered more uniformly. In other embodiments, the filter screen 56 is in other shapes such as a square.

The filter screen 56 is disposed to divide an internal space of the filter cartridge into an inner space of the filter screen 56 and an outer space of the filter screen 56. A hole in the filter screen 56 allows the cutting fluid to flow from one space to another space. Impurities such as thread residues and particles in the cutting fluid are blocked by the filter screen 56, such that the impurities are filtered. The ultrasonic cleaning assembly 120 is disposed to automatically clean the filter screen 56, such that a desirable cleaning effect and high reliability are achieved. Moreover, the filter screen 56 does not need to be disassembled during cleaning, and cleaning efficiency is high, which is conducive to improvement in machining efficiency of a wire cutting apparatus.

In some embodiments, the filter cartridge may include the cartridge body 55 and a cartridge cover 54. The cartridge cover 54 covers a top of the cartridge body 55 and is detachably connected to the cartridge body 55, such that the cartridge cover 54 is convenient to disassemble and mount, and further the filter screen 56 is convenient to disassemble and mount.

In some embodiments, the cartridge body 55 and the cartridge cover 54 is fixed by means of a threaded fastener, or through fastening or interference connection.

In some embodiments, a pressing member (not shown in the figure) is disposed between the filter screen 56 and the cartridge cover 54. The pressing member is made of an elastically deformable material. After the cartridge cover 54 is mounted on the cartridge body 55, the pressing member is tightly pressed by the cartridge cover 54, such that the filter screen 56 is fixed in an axial direction of the filter cartridge.

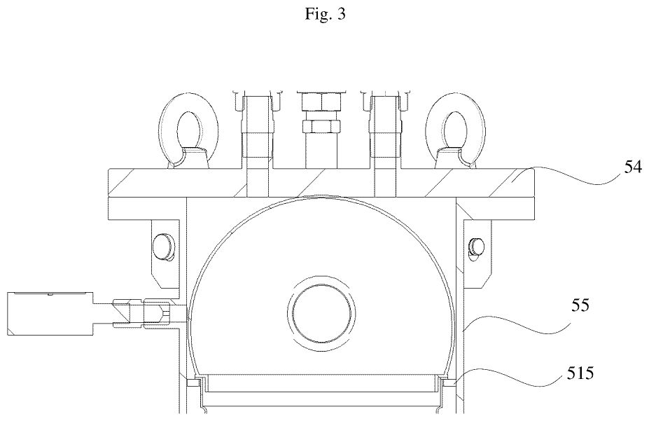

With reference to FIG. 3, FIG. 3 is a schematic enlarged diagram of a partial structure of a filter device for cutting fluid according to some embodiments of the disclosure. In some embodiments, a group of opposite bosses 515 are provided on an inner wall of a cartridge body 55, and part of a filter screen 56 is lapped at the bosses 515, such that the filter screen 56 is positioned.

In some embodiments, a sealing gasket is disposed a position of the filter screen 56 close to the cartridge body 55. For instance, the sealing gasket is disposed between the filter screen 56 and the boss 515, such that a sealing effect can be improved, and a possibility of mixed flowing of the cutting fluid before and after filter can be reduced.

In some embodiments, a dimension of at least part of the filter screen 56 in a radial direction is slightly greater than an inner diameter of the cartridge body 55, such that when the filter screen 56 is mounted in the cartridge body 55, the filter screen abuts against the inner wall of the cartridge body 55. In this way, the filter screen 56 is fixed in the radial direction, and a possibility of the filter screen 56 to shake in the cartridge body 55 is reduced.

In some embodiments, the filter screen 56 includes two parts, and the two parts are connected in a threaded manner, such that an ultrasonic cleaning assembly 120 is conveniently mounted in the filter screen 56.

In some embodiments, a filter bag (not shown in the figure) is disposed in the filter screen 56, such that the cutting fluid is filtered through the filter screen 56 and the filter bag, and a filter effect is better.

In some embodiments, the ultrasonic cleaning assembly 120 is configured to be connected to an external cleaning unit (not shown in the figure). The external cleaning unit is a water source or another cleaning liquid power apparatus. The external cleaning unit provides pressure for cleaning liquid so as to enable the cleaning liquid to enter the filter cartridge and disturb the cleaning liquid through ultrasonic waves.

With reference to FIG. 2, in some embodiments, the ultrasonic cleaning assembly 120 includes an ultrasonic transducer 121 and an ultrasonic amplitude transformer 122. One end of the ultrasonic transducer 121 is detachably connected with the cartridge cover 54. The other end of the ultrasonic transducer 121 is connected with the ultrasonic amplitude transformer 122. One end of the ultrasonic amplitude transformer 122 away from the ultrasonic transducer 121 penetrates the cartridge cover 54 and extends into the filter screen 56 in an axial direction of the filter screen 56.

The ultrasonic transducer 121 and the ultrasonic amplitude transformer 122 are disposed to conduct ultrasonic cleaning on the filter screen 56, such that high cleaning efficiency and a desirable cleaning effect are achieved.

In some embodiments, the ultrasonic cleaning assembly 120 is disposed at a center of the filter screen 56, such that a washing disturbance effect can be improved, and a better cleaning effect can be achieved.

In some embodiments, a sealing gasket (not shown in the figure) is disposed between the ultrasonic transducer 121 and the cartridge cover 54. For instance, a sealing recess is provided on an upper surface of the cartridge cover 54, the sealing gasket is located in the sealing recess, and part of the ultrasonic transducer 121 is located on the sealing gasket, such that the ultrasonic transducer 121 can tightly clamp the sealing gasket when being mounted on the cartridge cover 54 so as to achieve sealing.

In some embodiments, the filter cartridge further includes a sealing pressure plate 123. A center of the sealing pressure plate 123 is provided with an avoidance hole. Part of the ultrasonic transducer 121 penetrates the avoidance hole, and part of the ultrasonic transducer 121 abuts against the sealing pressure plate 123, such that when the sealing pressure plate 123 is fixed to the cartridge cover 54, the ultrasonic transducer 121 is pressed on the cartridge cover 54. The sealing pressure plate 123 is fixedly connected with the cartridge cover 54 by means of the threaded fastener (for instance, a screw).

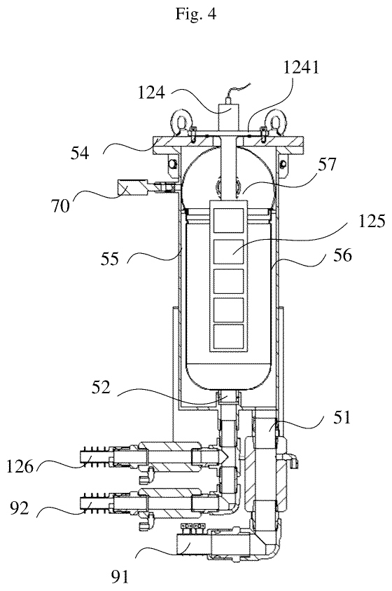

With reference to FIG. 4, FIG. 4 is a schematic structural diagram of a cutaway view of a filter device for cutting fluid according to some other embodiments of the disclosure. In some embodiments, an ultrasonic cleaning assembly 120 includes an ultrasonic vibrating rod 124 and an ultrasonic vibrator 125. One end of the ultrasonic vibrating rod 124 is detachably connected with a cartridge cover 54, and the other end of the ultrasonic vibrating rod 124 extends into a filter screen 56. The ultrasonic vibrator 125 is disposed in the ultrasonic vibrating rod 124 and extends into the filter screen 56.

The ultrasonic vibrating rod 124 and the ultrasonic vibrator 125 are disposed to conduct ultrasonic vibrating disturbance on the cleaning liquid in the filter screen 56, such that ultrasonic cleaning is conducted on the filter screen 56, and high cleaning efficiency and a desirable cleaning effect are achieved.

In some embodiments, the cartridge cover 54 is provided with a mounting hole (not shown in the figure). The ultrasonic vibrating rod 124 penetrates the mounting hole of the cartridge cover 54 and extends into the filter screen 56. The ultrasonic vibrator 125 is located in the ultrasonic vibrating rod 124 and further extends into the filter screen 56. In this way, a disturbance effect on the cleaning liquid in the filter screen 56 can be further enhanced, and a cleaning effect can be further improved.

In some embodiments, a sealing gasket (not shown in the figure) is disposed between the ultrasonic vibrating rod 124 and the cartridge cover 54. A sealing recess is provided on the cartridge cover 54, the sealing gasket is located in the sealing recess, and part of the ultrasonic vibrating rod 124 is located on the sealing gasket, such that the ultrasonic vibrating rod 124 can tightly clamp the sealing gasket when being mounted on the cartridge cover 54 so as to achieve sealing.

In some embodiments, a circumferential outer wall of the ultrasonic vibrating rod 124 is provided with a flange part 1241. A lower surface of the flange part 1241 is attached to an upper surface of the cartridge cover 54, and the flange part 1241 is fixed to the cartridge cover 54 through a threaded fastener. A diameter of the flange part 1241 is greater than that of the mounting hole, such that the flange part 1241 can be lapped at the upper surface of the cartridge cover 54. The flange part 1241 is disposed to fix the ultrasonic vibrating rod 124 to the cartridge cover 54.

In other embodiments, the filter cartridge further includes a sealing pressure plate 123. Reference is made to the sealing pressure plate 123 in the embodiments for a mounting method for the sealing pressure plate 123, which will not be repeated herein.

In some other embodiments, the ultrasonic cleaning assembly 120 further is disposed at an outer side of the filter screen 56, such that the filter screen 56 is washed from outside to inside.

In some embodiments, a number of ultrasonic cleaning assemblies 120 is one or more.

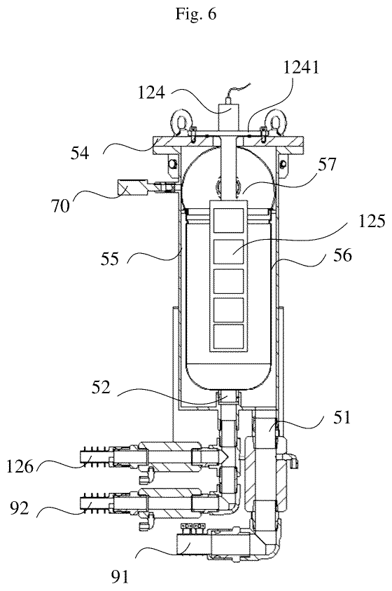

With reference to FIGS. 2 and 6, in some embodiments, the filter device 50 further includes a cleaning liquid inlet pipe 126. One end of the cleaning liquid inlet pipe 126 is in communication with a drain outlet 52. The drain outlet 52 is reused as a liquid inlet of the cleaning liquid inlet pipe 126 so as to allow the cleaning liquid to flow into. The cleaning liquid entering the filter cartridge through the cleaning liquid inlet pipe 126 washes the filter screen 56 from outside to inside, such that sewage left after washing is collected together in the filter screen 56 and discharged through the drain outlet 52 on a bottom of the filter screen 56. The drain outlet 52 is reused as the liquid inlet of the cleaning liquid inlet pipe 126, and no opening needs to be provided on the filter screen 56, such that a structure of the filter device 50 is simpler.

Specifically, a cleaning process of the filter device 50 is as follows:
The cleaning liquid enters through the cleaning liquid inlet pipe 126 and the drain outlet 52, and dirt on a bottom of the filter screen 56 is crushed and stirred in a liquid inlet process. After liquid feeding is completed, ultrasonic cleaning is conducted by means of an ultrasonic washing assembly 120, and the sewage left after cleaning is discharged through the drain outlet 52. The filtered cutting fluid flows into a filter circulation system through a cutting fluid outlet 51.

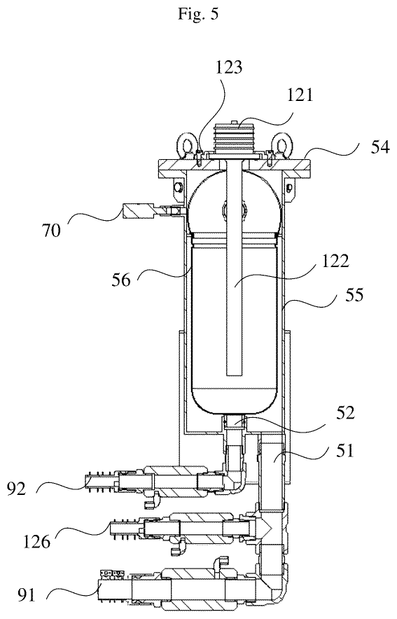

With reference to FIG. 5, FIG. 5 is a schematic structural diagram of a cutaway view of a filter device for cutting fluid according to some other embodiments of the disclosure. In some embodiments, a filter device 50 further includes a cleaning liquid inlet pipe 126. One end of the cleaning liquid inlet pipe 126 is in communication with a cutting fluid outlet 51. The cutting fluid outlet 51 is reused as a liquid inlet of the cleaning liquid inlet pipe 126 so as to allow cleaning liquid to flow into. The cleaning liquid entering a filter cartridge through the cleaning liquid inlet pipe 126 washes a filter screen 56 from outside to inside, such that sewage left after washing is collected together in the filter screen 56 and discharged through a drain outlet 52 on a bottom of the filter screen 56. The cutting fluid outlet 51 is reused as the liquid inlet of the cleaning liquid inlet pipe 126, and no opening needs to be provided on the filter screen 56, such that a structure of the filter device 50 is simpler.

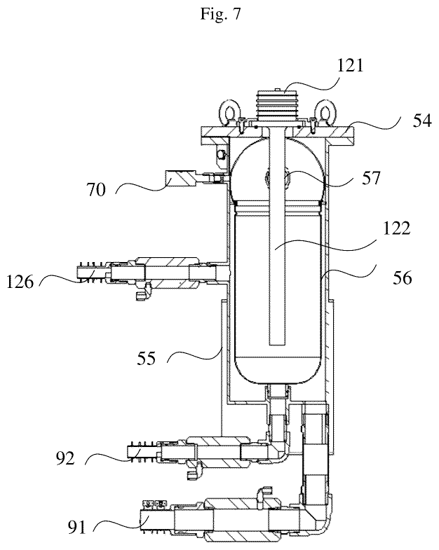

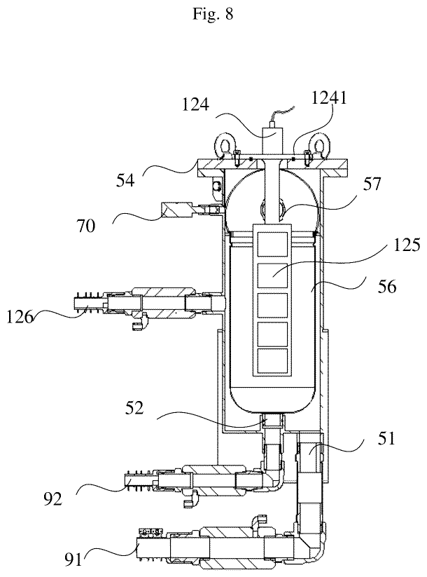

With reference to FIGS. 7 and 8, FIG. 7 is a schematic structural diagram of a cutaway view of a filter device for cutting fluid according to some other embodiments of the disclosure, and FIG. 8 is a schematic structural diagram of a cutaway view of a filter device for cutting fluid according to some other embodiments of the disclosure. In some embodiments, a filter device 50 further includes a cleaning liquid inlet pipe 126. The cleaning liquid inlet pipe 126 is connected with a circumferential side wall of a filter cartridge. A liquid inlet of the cleaning liquid inlet pipe 126 is located at an outer side of a filter screen 56.

In some embodiments, the cleaning liquid inlet pipe 126 is disposed on a middle-upper portion of a cartridge body 55. Cleaning liquid entering the cartridge body 55 through the cleaning liquid inlet pipe 126 cleans the filter screen 56 from outside to inside, and the cleaning liquid further cleans the filter screen 56 at a lower part under the action of gravity, such that a cleaning effect is better.

In some embodiments, the filter device 50 further includes a pressure measurement assembly 70. The pressure measurement assembly 70 is detachably mounted on the cartridge body 55 and configured to measure pressure of the cutting fluid in the filter cartridge, such that the filter device 50 has enough power to convey the cutting fluid to a spraying device 20.

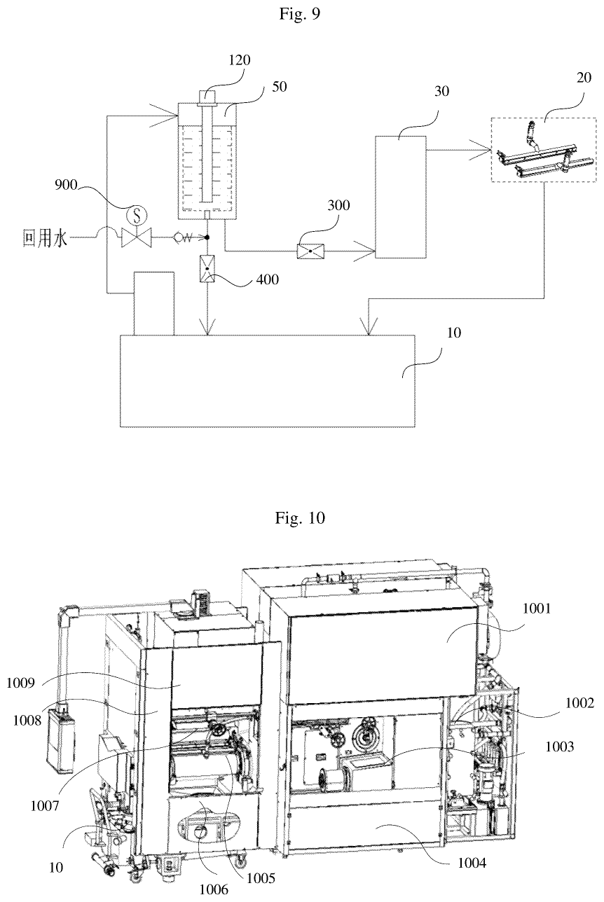

With reference to FIGS. 1 and 9, FIG. 9 is a schematic structural diagram of a filter circulation system for cutting fluid according to some other embodiments of the disclosure. In some embodiments, a filter device 50 further includes a cutting fluid outlet valve 300, a drain valve 400 and a cleaning control valve 900. The cutting fluid outlet valve 300 is located at one end of a cutting fluid output pipe 91 close to a cutting fluid outlet 51. The drain valve 400 is located on a drain pipe 92 and below a cleaning liquid inlet pipe 126, such that when the drain pipe 92 is closed by means of the drain valve 400, on-off states of the cleaning liquid inlet pipe 126 cannot be influenced. Meanwhile, after the drain valve 400 is turned on, sewage at a front end of a pipe is completely discharged. The cleaning control valve 900 is located on the cleaning liquid inlet pipe 126.

In some embodiments, the cutting fluid outlet valve 300 is a pinch valve, and the drain valve 400 is a pinch valve.

In some embodiments, a spraying device 20 includes several spraying tubes and is configured to spray the cutting fluid onto a workpiece cutting zone.

In some embodiments, a collecting device 80 is a collecting tank or a collecting funnel, and is disposed below the workpiece cutting zone. The collecting tank or the collecting funnel is provided with a collecting channel in communication with a liquid supply device 10 so as to convey the cutting fluid.

In some embodiments, the liquid supply device 10 includes a liquid supply cylinder configured to accommodate the cutting fluid. The liquid supply cylinder is provided with a return port of the cutting fluid. The return port is connected with the collecting device 80. The cutting fluid returned from the collecting device 80 is returned to the liquid supply cylinder. The return port is provided with a rubber strip for sealing. Meanwhile, the collecting device 80 further is provided with a liquid returning and filter assembly internally provided with a filter screen, such that the cutting fluid returned is filtered. The liquid supply device 10 provides power for the cutting fluid, so as to implement circulation through the liquid supply device 10, the filter device 50 and the spraying device 20. A mortar pump is used as the liquid supply device 10.

In some embodiments, the filter circulation system further includes a heat exchange device 30. The heat exchange device 30 is connected between the filter device 50 and the spraying device 20 and configured to cool the cutting fluid.

In some embodiments, the filter circulation system further includes a flowmeter 40. An input end of the flowmeter 40 is connected with the heat exchange device 30, and an output end of the flowmeter is connected with the spraying device 20, such that a flow amount of the cutting fluid is monitored.

In some embodiments, one end of a cutting fluid input pipe 90 is in communication with the liquid supply device 10, and the other end of the cutting fluid input pipe is in communication with a cutting fluid inlet 57 of the filter device 50. One end of a cutting fluid output pipe 91 is in communication with the heat exchange device 30, and the other end of the cutting fluid output pipe is in communication with a cutting fluid outlet 51 of the filter device 50. One end of the drain pipe 92 is in communication with a drain outlet 52 of the filter device 50, and the other end of the drain pipe is in communication with the liquid supply device 10.

Specifically, circulation steps of the filter circulation system are as follows:

Before cutting operation, for instance, slicing, the cutting fluid is stored in the liquid supply device 10.

In slicing operation, the cutting fluid enters the filter cartridge from the liquid supply device 10 through the cutting fluid inlet 57. In this case, the filter cartridge is in a state in which a backwashing gas pipe is disconnected, the cutting fluid outlet 51 is opened, the drain pipe 92 is disconnected, and the cleaning liquid inlet pipe 126 is disconnected. After the cutting fluid is filtered by a filter screen 56 and then flows out of the cutting fluid outlet 51, the cutting fluid enters the heat exchange device 30. The heat exchange device 30 cools the cutting fluid with factory cooling water. The cooled cutting fluid is uniformly sprayed onto the workpiece cutting zone by means of a spraying tube of the spraying device 20 through the flowmeter 40, and then is returned to the liquid supply device 10 through a bottom of a cutting chamber, such that circulation of the cutting fluid is implemented in a machining process.

When the cutting fluid is returned after one time of cutting, the cutting fluid outlet 51 (a pinch valve 511 at the cutting fluid outlet) is closed, and the drain outlet 52 (a pinch valve 510 of the drain outlet is turned off) is opened. The cutting fluid in the heat exchange device 30 is returned to the filter cartridge, and then is returned to the liquid supply cylinder from the drain outlet 52 or the cutting fluid outlet 51 of the filter cartridge through a return tube together with the cutting fluid remaining in the filter cartridge. That is, both the drain pipe 92 and the cutting fluid output pipe 91 are in communication with the return tube, and the cutting fluid is discharged into a trench from a water outlet of the liquid supply device 10. After slicing operation is completed, the cutting fluid output pipe 91 is disconnected, and the drain pipe 92 is connected, such that the cutting fluid left in the filter cartridge is returned to the liquid supply device 10, and is discharged into the trench from a water outlet of the liquid supply cylinder.

After slicing, the cleaning liquid inlet pipe 126 is opened to ensure that the filter cartridge is full of cleaning liquid during cleaning, and an ultrasonic cleaning assembly 120 is opened. The ultrasonic cleaning assembly 120 converts electric energy into ultrasonic energy and transmits the energy to scale, water and an inner wall of a pipe according to own rules, so as to obtain great energy. Shock generated during transmission of ultrasonic waves causes scale, water and the filter screen 56 to resonate. Due to different oscillation frequencies of the scale, the water and the filter screen 56, water molecules in the filter cartridge violently collide with each other to generate a strong impact force. The force impacts a scale layer on the filter screen 56, such that the layer becomes brittle, is peeled off, falls off and is crushed, and then is discharged together with sewage. Thus, the filter screen 56 is thoroughly cleaned by the ultrasonic cleaning assembly 120. After cleaning is completed, the drain pipe 92 is opened, and sewage generated after cleaning returns to the liquid supply device 10 and is discharged through the trench.

With reference to FIG. 10, FIG. 10 is a schematic structural diagram of a wire cutting machine according to some other embodiments of the disclosure. In some embodiments, the wire cutting machine includes a circulation system for cutting fluid, an electric control cabinet 1001, a liquid path system 1002, a winding chamber assembly 1003, a winding chamber shield assembly 1004, a cutting device, and a cutting zone assembly 1008. The cutting zone assembly 1008 includes a lathe bed assembly 1006, a spindle assembly 1005, a four-column feeding and swinging mechanism 1007, and a cutting zone shield assembly 1009.

The electric control cabinet 1001 is configured to arrange a cabinet of an electrical assembly. The liquid path system 1002 provides the cutting zone assembly 1008 with a cutting fluid supply assembly for cutting liquid, a cutting fluid heat exchange assembly configured to cool the cutting fluid and a cooling liquid heat exchange assembly configured to cool a slicer apparatus. The winding chamber assembly 1003 is configured to wind, unwind, arrange wires and serves as a tension control zone of steel wires.

The cutting device is configured to cut a workpiece. The cutting device is a ring wire cutting device or a multi-wire cutting device. A specific structure of the cutting device is set as required, and falls within the protection scope of the disclosure. A control device is a programmable logic controller (PLC), a display screen or another control apparatus. In some embodiments, the control device is disposed on the wire cutting machine. In some embodiments, the control device is connected with a master control apparatus in a master control room in a wireless communication manner, such that real-time monitoring, data uploading and other operation of each wire cutting machine are implemented in the master control room.

With silicon rod slicing as an instance, the cutting zone assembly 1008 is a zone assembly configured to cut crystal rods, and the lathe bed assembly 1006 is used as a bearing component of the cutting assembly and the winding chamber assembly 1003. The spindle assembly 1005 is provided with two sets of high-speed rotating spindle assemblies 1005 with an internal circulating and liquid cooling function, which are disposed at left and right sides respectively. Diamond wires are wound around the spindle assemblies so as to form a cutting zone, and rear ends of spindles are both connected with driving motors. The four-column feeding and swinging mechanism 1007 is a vertical feeding mechanism with a swinging function, and is guided by four guide rails.

Generally, the cutting machine is provided a main rack. One end of the main rack in a length direction is provided with a cutting zone rack. In a vertical direction, the main rack is sequentially provided with the electric control cabinet 1001, the winding chamber assembly 1003 and the winding chamber shield assembly 1004 from top to bottom. Part of the liquid path system 1002 is disposed at one end of the main rack away from the lathe bed assembly 1006. In a vertical direction, the cutting zone rack is sequentially provided with the cutting zone shield assembly 1009, the cutting zone assembly 1008, the four-column feeding and swinging mechanism 1007, the spindle assembly 1005, a liquid supply assembly, and the lathe bed assembly 1006 from top to bottom. The arrangement mode optimizes mounting space of the wire cutting machine, such that each structure is compact, and space utilization is rational.

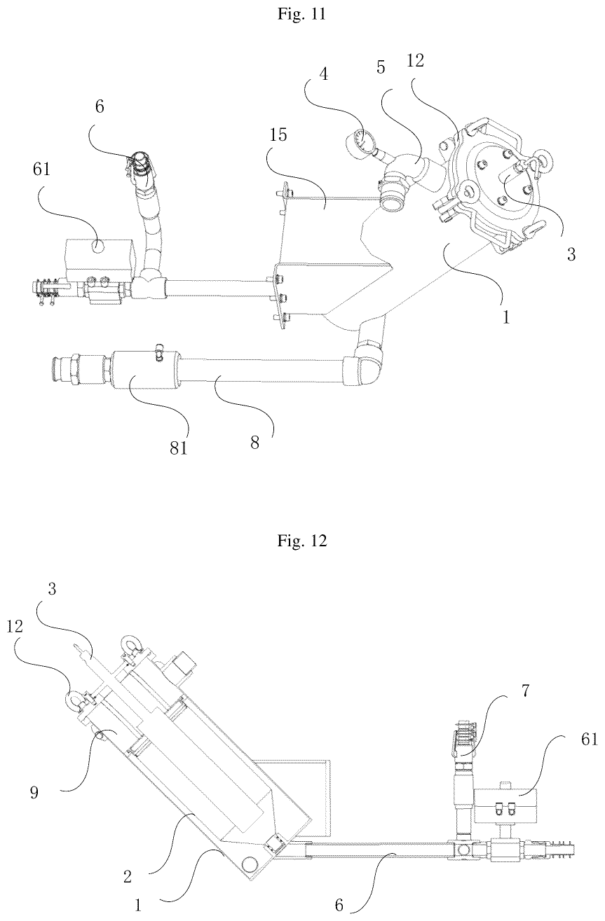

With reference to FIGS. 11 and 12, FIG. 11 is a schematic structural diagram of a filter device according to some other embodiments of the disclosure, and FIG. 12 is a schematic structural diagram of a cutaway view of a filter device according to some other embodiments of the disclosure. In some embodiments, the filter device includes a filter cartridge 1, a filter screen 2, an ultrasonic cleaning assembly 3, and a control assembly. The filter screen 2 is disposed in the filter cartridge 1. The ultrasonic cleaning assembly 3 extends into the filter screen 2, and is configured to conduct ultrasonic cleaning on the filter screen 2. The control assembly is connected with the ultrasonic cleaning assembly 3, and is configured to control, in response to determining that a wire cutting machine is in a cutting operation state, the ultrasonic cleaning assembly 3 to clean the filter screen 2.

The ultrasonic cleaning assembly 3 is disposed to automatically clean the filter screen 2, such that a desirable cleaning effect and high reliability are achieved. Moreover, the filter screen 2 does not need to be disassembled during cleaning, and cleaning efficiency is high, which is conducive to improvement in machining efficiency of a wire cutting apparatus.

In some embodiments, the control assembly is a PLC that controls the ultrasonic cleaning assembly 3 to operate by controlling relay engagement of the ultrasonic cleaning assembly 3. As cleaning of a vibrating rod is conducted, pressure of the filter cartridge 1 is reduced. In response to determining that the pressure drops to a certain value, a PLC system controls a relay to be disconnected, and the vibrating rod stops working.

In some embodiments, the filter cartridge 1 is a sealed cavity, such that a possibility of cutting fluid leakage can be reduced.

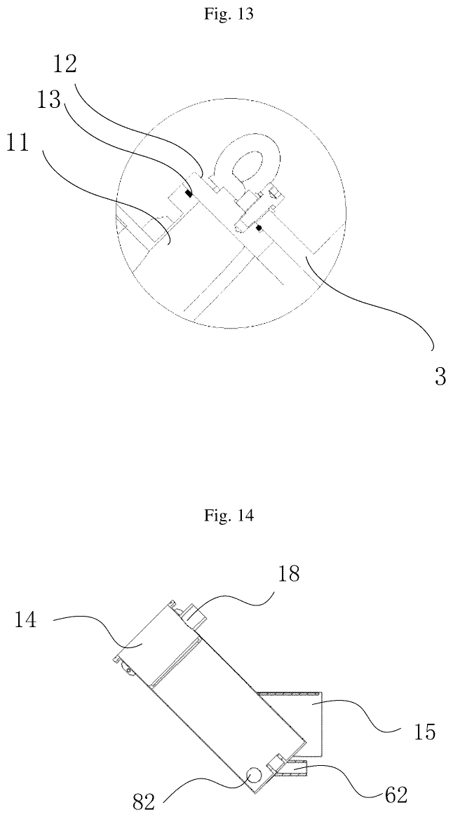

With reference to FIGS. 13 and 14, FIG. 13 is a schematic diagram of a partial structure of a filter device according to some other embodiments of the disclosure, and FIG. 14 is a schematic structural diagram of a filter device according to some other embodiments of the disclosure. In some embodiments, the filter cartridge 1 includes a filter cartridge body 11 and a cartridge cover 12. The cartridge cover 12 is located on a top of the filter cartridge body 11, and the filter cartridge body and the cartridge cover are detachably fixed to each other, and for instance, fixed by means of a threaded fastener.

In some embodiments, a sealing ring 13 is disposed between the filter cartridge body 11 and the cartridge cover 12. A fixing ring 14 is disposed on an inner wall of the filter cartridge body 11 in a circumferential direction. The fixing ring 14 and the filter cartridge body 11 are integrally disposed to facilitate production and machining.

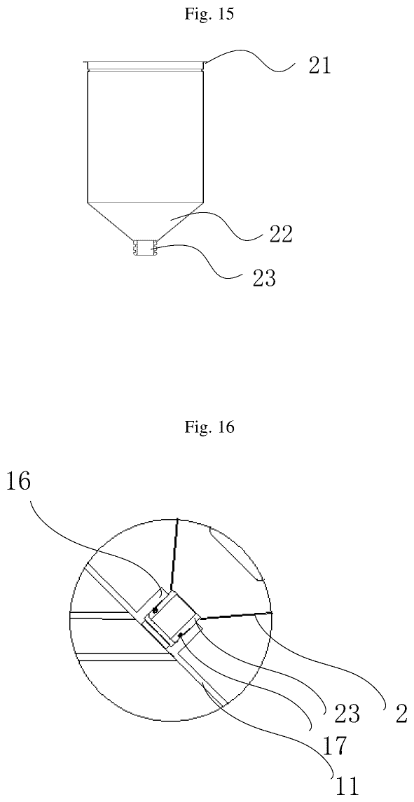

With reference to FIG. 15, FIG. 15 is a schematic diagram of a partial structure of a filter device according to some other embodiments of the disclosure. In some embodiments, an outer wall of the filter screen 2 is provided with a flange 21. The filter screen 2 is overlapped with the fixing ring 14 by means of the flange 21. A compression ring 9 is disposed above a filter cartridge body 11 to tightly press the filter screen 2 on the fixing ring 14 from top to bottom, so as to implement fixing.

In some embodiments, an axis of a filter cartridge 1 has a preset inclination angle with a horizontal direction, such that draining and cutting fluid output are facilitated. The filter cartridge 1 is connected to a frame body of a wire cutting machine by means of a fixing mounting plate 15. The filter cartridge 1 is obliquely disposed, and is connected with a cutting fluid drain pipe 6, a cleaning liquid inlet pipe 7, a cutting fluid output pipe 8, and a cutting fluid input pipe. The cutting fluid input pipe is generally disposed above a filter cartridge body 11, the cutting fluid drain pipe 6 is located on a bottom wall of the filter cartridge body 11, and the cleaning liquid inlet pipe 7 is disposed at a front end of the cutting fluid drain pipe 6. The cutting fluid output pipe 8 is located below a side wall of the filter cartridge body 11 so as to fully filter the cutting fluid.

With reference to FIG. 16, FIG. 16 is a schematic diagram of a partial structure of a filter device according to some other embodiments of the disclosure. In some embodiments, a filter screen 2 is a stainless steel filter screen with a mesh number of 100-600.

In some embodiments, an entire bottom of the filter screen 2 is of a conical structure, such that sewage discharge of an internal space of the filter screen is facilitated, avoiding a situation that sewage is not discharged completely. In the embodiments, in order to improve a filter effect, the bottom of the filter screen 2 is provided with a conical part 22, such that impurities can be concentrated at the bottom of the filter screen 2 and discharged out of the filter screen 2 conveniently. A top end of the conical part 22 is provided with a mounting column 23. The mounting column 23 is provided with a through hole in communication with an inner cavity of the filter screen 2. The mounting column 23 is of a cylindrical structure, and is integrated with the conical part 22, such that production and machining are facilitated.

In some embodiments, a bottom wall of a filter cartridge 1 is provided with a drain outlet 62. A mounting ring wall 16 extending inward is disposed on the drain outlet 62 in a circumferential direction. An outer side of the mounting ring wall 16 is provided with sealing ring mounting recesses. A plurality of sealing ring mounting recesses are provided in an axial direction of the mounting ring wall 16. Sealing rings 17 are disposed in the sealing ring mounting recesses. The mounting column 23 is inserted into the mounting ring wall 16, and the mounting ring wall 16 and the mounting column 23 fixed in a sealed manner through the sealing rings 17. Bottoms of the filter screen 2 and the filter cartridge 1 are sealed. Meanwhile, the cutting fluid is discharged into a drain pipe only through an outlet formed by the mounting column 23. Further, a draining effect of impurities is improved.

In some embodiments, a cutting fluid drain pipe 6 is in communication with the drain outlet 62. The cutting fluid drain pipe 6 is provided with a cutting fluid drain control valve 61 configured to control the cutting fluid drain pipe 6 to be turned on and off. A cleaning liquid inlet of a cleaning liquid inlet pipe 7 is in communication with the filter cartridge 1 through the cutting fluid drain pipe 6. The cleaning liquid inlet pipe 7 is located between the drain outlet 62 and the cutting fluid drain control valve 61. Thus, cleaning liquid is injected from bottom to top, and impurities on the bottom of the filter screen 2 are disturbed, such that an ultrasonic cleaning assembly 3 is convenient to clean, and a cleaning effect of the filter screen 2 is improved.

In some embodiments, the filter device further includes a cutting fluid output pipe 8 and a flow measurement assembly. The cutting fluid output pipe 8 is in communication with a cutting fluid outlet. The cutting fluid output pipe 8 is configured to discharge the cutting fluid filtered. The flow measurement assembly is disposed on the cutting fluid output pipe and configured to measure a cutting fluid output flow value of the filter cartridge 1.

In some embodiments, the cutting fluid output pipe 8 is provided with the cutting fluid outlet 82 and a cutting fluid output control valve 81. The cutting fluid outlet 82 is located below a side wall of the filter cartridge 1. The cutting fluid output control valve 81 is configured to control a pipe to be turned on and off.

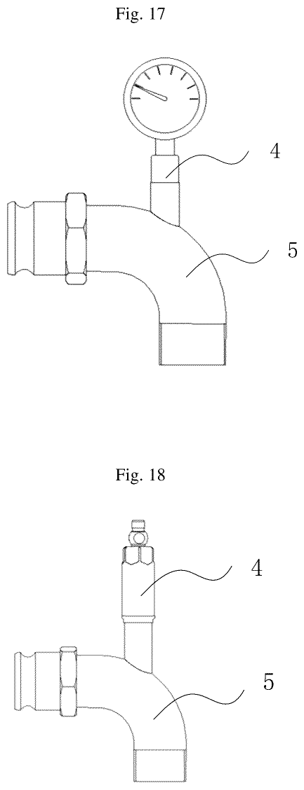

With reference to FIGS. 17 and 18, FIG. 17 is a schematic diagram of a partial structure of a filter device according to some other embodiments of the disclosure, and FIG. 18 is a schematic diagram of a partial structure of a filter device according to some other embodiments of the disclosure. In some embodiments, the filter device further includes a cutting fluid input pipe (not shown in the figure) and a pressure measurement assembly 4. The cutting fluid input pipe is in communication with a cutting fluid inlet 18. The cutting fluid input pipe is configured to enable communication between inside of a filter screen 2 and the outside. The pressure measurement assembly 4 is disposed on the cutting fluid input pipe and configured to measure an internal pressure value of a filter cartridge.

In some embodiments, the cutting fluid input pipe includes a filter cartridge connector 5. The filter cartridge connector 5 is located above a side wall of the filter cartridge 1. The pressure measurement assembly 4 is located on the filter cartridge connector 5.

The cutting fluid inlet 18 of the filter cartridge 1 is connected with a water outlet of a liquid supply cylinder, and a cutting fluid outlet 82 is connected with an inlet of a heat exchanger in a cutting fluid system. During liquid supply circulation, the cutting liquid enters the filter screen from the liquid supply cylinder through a liquid supply pump via the cutting fluid inlet 18. After the cutting fluid is filtered by a stainless steel filter screen, the cutting fluid enters an external space of the filter screen in the cartridge and flows into the heat exchanger through the cutting fluid outlet 82. Meanwhile, impurities such as thread residues and silicon slag in the cutting fluid are intercepted by the filter screen and remain in an internal space of the filter screen. Also, a cutting fluid output pipe 8 is provided with a cutting fluid output control valve 81, such that the pipe can be controlled to be opened and closed. A drain outlet 62 of the filter cartridge 1 is connected with the liquid supply cylinder or a trench. After cutting operation is completed, the impurities intercepted in the internal space of the filter screen are discharged into the liquid supply cylinder or the trench through the drain outlet 62. A drain pipe is provided with a cutting fluid drain control valve 61 so as to control the pipe to be opened and closed. Meanwhile, a cleaning liquid inlet pipe 7 is connected between the cutting fluid drain control valve 61 on the drain pipe and the filter cartridge 1 by means of a tee joint. Factory water pass the cleaning liquid inlet pipe 7. Ultrasonic cleaning water is controlled to be injected into the filter cartridge 1 by means of a cleaning liquid control valve.

States of valves under various working conditions are as follows:
In a cutting process: the cutting fluid drain control valve 61 and the cleaning fluid control valve are turned off, and the cutting fluid output control valve 81 is turned on. That is, the drain pipe and the cleaning liquid inlet pipe 7 are closed, and the cutting fluid output pipe 8 is connected. Thus, it is ensured that a liquid supply system implements cutting fluid circulation of “liquid supply cylinder-filter cartridge 1-heat exchanger-cutting zone-liquid supply cylinder”.
In a draining process: the cutting fluid drain control valve 61 is turned on, the cleaning liquid control valve is turned off, the cutting fluid output control valve 81 is turned off, the drain pipe is opened, and a cutting fluid circulation and cleaning pipe is closed, such that impurities and sewage in an internal space of the filter screen are discharged into the liquid supply cylinder or the trench through the drain outlet 62.

In a water injection process of ultrasonic cleaning of the filter cartridge 1: the cutting fluid drain control valve 61 is turned off, the cutting fluid output control valve 81 is turned off, and the cleaning liquid control valve is turned on. That is, the cleaning liquid inlet pipe 7 is opened, and a cutting fluid circulation and draining pipe is closed. Thus, it is ensured that the filter cartridge 1 is full of water during ultrasonic cleaning, and a cleaning effect is ensured.

Specifically, an ultrasonic cleaning assembly 3 includes an ultrasonic vibrating rod and an ultrasonic vibrator. The ultrasonic vibrator is located in the ultrasonic vibrating rod and extends in an axial direction of the ultrasonic vibrating rod. One end of the ultrasonic vibrating rod is fixedly connected with a cartridge cover 12, and the other end of the ultrasonic vibrating rod extends into the filter screen 2.

Specifically, one end of the ultrasonic vibrating rod is detachably and fixedly connected with the cartridge cover 12. The cartridge cover 12 is provided with a mounting hole. The ultrasonic vibrating rod penetrates the mounting hole of the cartridge cover 12. The other end of the ultrasonic vibrating rod extends into the filter screen 2. The ultrasonic vibrator is sleeved with the ultrasonic vibrating rod and extends into the filter screen 2. The arrangement mode can optimize a disturbance effect of cleaning liquid in the filter screen 2 and improve the cleaning effect. It is understood that a sealing gasket is also disposed between the ultrasonic vibrating rod and the cartridge cover 12. The cartridge cover 12 is provided with a sealing recess, and the sealing gasket is located in the sealing recess. The sealing gasket is tightly pressed between the ultrasonic vibrating rod and the cartridge cover 12 through fixing between the ultrasonic vibrating rod and the cartridge cover.

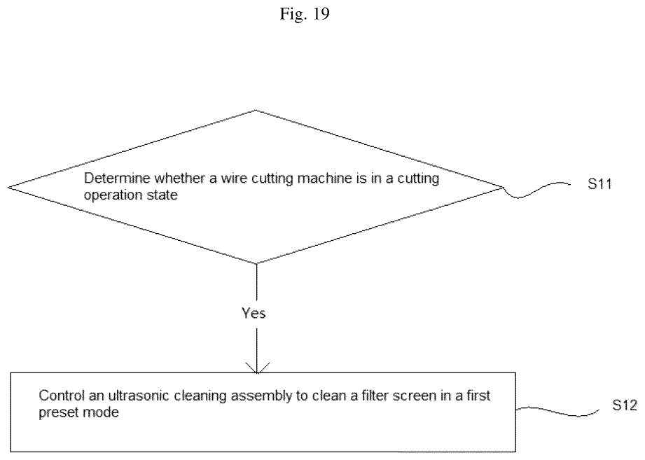

With reference to FIG. 19, FIG. 19 is a schematic flow diagram of a method for cleaning a filter device for cutting fluid according to some embodiments of the disclosure. The filter device includes a filter cartridge 1, a filter screen 2 and an ultrasonic cleaning assembly 3. The filter screen 2 is disposed in the filter cartridge 1. At least part of the ultrasonic cleaning assembly 3 is disposed in the filter screen 2 and configured to conduct ultrasonic cleaning on the filter screen 2.

The cleaning method includes the following steps:
S11, whether a wire cutting machine is in a cutting operation state is determined.
S12, in response to determining that the wire cutting machine is in the cutting operation state, the filter screen 2 is cleaned by the ultrasonic cleaning assembly 3.

In some embodiments, the cutting operation state is determined by means of a power-on signal, a number of rotation times of an electric motor of the wire cutting machine or other signals. Meanwhile, it is generally conceived that the cutting fluid starts to circulate in the cutting operation state. That is, a result of whether the cutting fluid is input into the filter cartridge 1 is used as a signal to determine whether the wire cutting machine is in the cutting operation state. That is, in response to detecting that the cutting fluid passes the cutting fluid input pipe of the filter cartridge 1, it is considered that the wire cutting machine is currently in the cutting operation state. After the filter screen 2 is cleaned, the cutting fluid left after cleaning is controlled to be discharged out of the filter cartridge 1, and cutting fluid system circulation is continued. That is, the filter screen 2 is cleaned in a non-stop manner in a cutting fluid circulation process, such that filter accuracy of the filter screen 2 in an entire cutting fluid circulation operation process can be improved, and a disconnection rate can be reduced.

In some embodiments, a cleaning method for the filter screen 2 by the ultrasonic cleaning assembly 3 is as follows: the ultrasonic cleaning assembly 3 cleans the filter screen 2 in a preset cleaning cycle. The preset cleaning cycle includes first operation duration and a first interval length. The first operation duration is 5 s, and the first interval length is 10 s. In a complete operation cycle of the wire cutting machine, cleaning operation is continuously conducted with the preset cleaning cycle.

The preset cleaning cycle is implemented by setting first operation duration and a first interval length that are different, which is specifically set with reference to the above description. In another embodiment, the preset cleaning cycle changes with time according to differences of the cutting operation duration. For instance, if the cutting operation duration is 30 min, first operation duration and a first interval length may both be set as 5 s in first 10 min; first operation duration may be set as 8 s and a first interval length is set as 5 s in second 10 min; and first operation duration may be set as 10 s and a first interval length is set as 3 s in third 10 min. The first operation duration and the first interval length are set as required, both of which fall within the protection scope of the disclosure.

In some other embodiments, a cleaning method for the filter screen 2 by the ultrasonic cleaning assembly 3 is as follows: the ultrasonic cleaning assembly continuously cleans the filter screen.

In the disclosure, in response to determining that the wire cutting machine is in the cutting operation state, the ultrasonic cleaning assembly 3 is controlled to clean the filter screen 2 in a first preset mode, such that silicon powder attached to the filter screen 2 is cleared, and the silicon powder is prevented from being attached to the filter screen 2 and blocking mesh holes. Thus, the cutting fluid with the silicon powder can smoothly pass the filter screen 2. The filter device using the above cleaning control method is applied to a filter screen 2 having a large mesh number on the premise of satisfying use requirements of cutting fluid flow, which is conducive to improvement in accuracy of filter impurities by the cutting fluid. Thus, a problem of jumpers and broken wires during slicing is reduced, and cutting quality is improved.

In some embodiments, before the filter screen is cleaned by the ultrasonic cleaning assembly, the cleaning method further includes the following step:
S13, whether an internal pressure value of the filter cartridge is greater than a first preset pressure value is determined.

In response to determining that the internal pressure value of the filter cartridge is greater than the first preset pressure value, the step that the filter screen is cleaned by the ultrasonic cleaning assembly is executed.

The internal pressure value of the filter cartridge 1 is measured, such that a degree of blockage of mesh holes of the filter screen 2 is indirectly inferred. If the internal pressure value is greater than the first preset pressure value, it is considered that the mesh holes of the filter screen 2 need to be cleaned. The first preset pressure value is set as 0.1 Mpa-0.5 Mpa, and is set according to working needs of the wire cutting machine. The internal pressure value is measured by arranging the pressure measurement assembly 4 on the filter cartridge 1, and the pressure measurement assembly 4 is a pressure sensor. Reference is made to the prior art for a specific mounting method of the pressure measurement assembly.

In some embodiments, before the filter screen is cleaned by the ultrasonic cleaning assembly, the cleaning method further includes the following steps:
S14, whether the internal pressure value of the filter cartridge is smaller than a second preset pressure value is determined, where the second preset pressure value is smaller than or equal to the first preset pressure value.
S15, in response to determining that the internal pressure value of the filter cartridge is smaller than the second preset pressure value, the ultrasonic cleaning assembly is enabled to stop cleaning the filter screen.

If the internal pressure value of the filter cartridge 1 is smaller than the second preset pressure value, it is considered that mesh holes of the filter screen 2 are not blocked and in a good condition currently, and cleaning of the filter screen 2 is temporarily stopped. The second preset pressure value is set as 0.08 Mpa-0.1 Mpa, and for instance, 0.08 Mpa or 0.1 Mpa. Thus, energy is saved while filter accuracy of the filter screen 2 is ensured, and cutting cost is controlled.

In some embodiments, before the filter screen is cleaned by the ultrasonic cleaning assembly, the method further includes the following step:
S16, whether a cutting fluid output flow value of the filter cartridge is smaller than a preset flow value is determined.

In response to determining that the cutting fluid output flow value of the filter cartridge is smaller than the preset flow value, the step that the filter screen is cleaned by the ultrasonic cleaning assembly is executed.

In some embodiments, a flow measurement assembly is disposed on a cutting fluid output pipe 8 of the filter cartridge 1 so as to measure the cutting fluid output flow value of the filter cartridge 1. The flow measurement assembly is a flowmeter. In response to determining that the cutting fluid output flow value is smaller than a first preset flow value, the ultrasonic cleaning assembly 3 is controlled to clean the filter screen 2. In one example, the internal pressure value of the filter cartridge 1 and the cutting fluid output flow value of the filter cartridge 1 may be determined simultaneously. That is, in response to determining that the wire cutting machine is in the cutting operation state, the internal pressure value of the filter cartridge 1 is greater than the first preset pressure value, and the cutting fluid output flow value of the filter cartridge 1 is smaller than the first preset flow value, the ultrasonic cleaning assembly 3 is controlled to clean the filter screen 2. Thus, a blocking condition of the filter screen 2 is further accurately determined, such that false alarm can be prevented, energy consumption can be reduced, and meanwhile, service life of the ultrasonic cleaning assembly 3 can be prolonged.

In some embodiments, after it is determined that the wire cutting machine is in the cutting operation state, the cleaning method further includes the following step:
S17, whether cutting operation duration of the wire cutting machine is longer than or equal to first preset duration is determined.

In response to determining that the cutting operation duration of the wire cutting machine is longer than or equal to the first preset duration, the step that the filter screen is cleaned by the ultrasonic cleaning assembly is executed.

That is, after the wire cutting machine is in the cutting operation state for at least the first preset duration, the filter screen 2 is cleaned by the ultrasonic cleaning assembly 3. In this way, the filter screen 2 can be cleaned after the wire cutting machine is turned on and runs stably, and the system can be prevented from being overloaded or other operation accidents caused by excessive running power when the machine is just turned on. System security is improved.

Meanwhile, in another example, a cutting frequency is determined after S11, which serves as a precondition for the ultrasonic cleaning assembly 3 to clean the filter screen 2.

In some embodiments, before the filter screen is cleaned by the ultrasonic cleaning assembly, the cleaning method further includes the following step:
S18, whether a cutting frequency of the wire cutting machine is greater than or equal to a preset cutting frequency is determined.

In response to determining that the cutting frequency of the wire cutting machine is greater than or equal to the preset cutting frequency, the step that the filter screen is cleaned by the ultrasonic cleaning assembly is executed.

The above method is designed to clean the filter screen 2 after the wire cutting machine is in the cutting operation state and runs stably, and also avoid a situation that the filter screen 2 is cleaned too many times in a process without cutting. In this way, energy consumption of the system is reduced, and meanwhile, service life of the ultrasonic cleaning assembly 3 is prolonged.

Based on all the above embodiments, the first preset mode is to control the ultrasonic cleaning assembly 3 to continuously clean the filter screen 2, thus further improving filter accuracy of the filter screen 2 in an entire operation process and improving a filter effect. Alternatively, in another example, the first preset mode is specifically to control the ultrasonic cleaning assembly 3 to clean the filter screen 2 in the preset cleaning cycle. The preset cleaning cycle is implemented by setting first operation duration and a first interval length that are different, which is specifically set with reference to the above description. In another example, the preset cleaning cycle changes with time according to differences of the cutting operation duration. For instance, if the cutting operation duration is 30 min, first operation duration and a first interval length both are set as 5 s in first 10 min; first operation duration is set as 8 s and a first interval length is set as 5 s in second 10 min; and first operation duration is set as 10 s and a first interval length is set as 3 s in third 10 min. The first operation duration and the first interval length is set as required, both of which fall within the protection scope of the disclosure.

In some embodiments, the cleaning method further includes the following steps:
S110, whether a wire cutting machine is in a non-cutting operation state is determined.
S120, in response to determining that the wire cutting machine is in the non-cutting operation state, cleaning liquid is injected into the filter cartridge, and the filter screen is cleaned by the ultrasonic cleaning assembly.
S130, whether operation duration of the ultrasonic cleaning assembly is longer than or equal to second preset duration is determined.
S140, in response to determining that the operation duration of the ultrasonic cleaning assembly is longer than or equal to the second preset duration, the ultrasonic cleaning assembly is enabled to stop cleaning.

The non-cutting operation state indicates all states of the wire cutting machine other than a cutting operation state, which are all the non-cutting operation states. For instance, a state in which the wire cutting machine is turned on and then conducts no cutting operation and a feeding and discharging state in which a cutting device of the wire cutting machine suspends operation and materials are fed and discharged, are both included in the non-cutting operation states of the disclosure. In some embodiments, if the non-cutting operation state is the feeding and discharging state, the cutting device of the wire cutting machine is in an operation suspending state while a material feeding device conducts material feeding and discharging. In this way, the filter screen 2 is cleaned in an interval between two times of cutting operation, thus ensuring cutting operation efficiency and a cleaning effect of the filter screen. Meanwhile, the entire process is more compact.

In response to determining that the wire cutting machine is in the non-cutting operation state, a cutting fluid drain pipe 6 and a cutting fluid output pipe 8 are controlled to be disconnected. That is, a drain valve and a cutting fluid outlet valve are controlled to be turned off. Thus, cleaning water does not flow into the cutting fluid output pipe 8, and further a possibility of mixing of the cleaning water and spraying of the cleaning water out of a spraying device is reduced, such that cleanliness of the cutting fluid can be ensured. A cleaning liquid inlet pipe 7 is controlled to be turned on (a cleaning control valve is turned on) until the cleaning liquid fills the filter cartridge 1 of a circulation system for cutting fluid, and then the cleaning liquid inlet pipe 7 is closed, thus ensuring that the filter cartridge 1 is filled with water during cleaning. Ultrasonic operation is controlled with a working frequency range of 15 KHz≤f≤80 KHz, and the filter screen 2 is cleaned at a preset frequency.

A preset amount is a preset size, and is set according to a size of the filter cartridge 1, such that the ultrasonic cleaning assembly can achieve a desirable cleaning effect on the filter screen 2. In some embodiments the cleaning liquid inlet pipe 7 is controlled to be turned on until the cleaning liquid fills the filter cartridge 1 of the circulation system for cutting fluid.

In response to determining that the wire cutting machine is in the non-cutting operation state, a drain pipe 92 and a cutting fluid output pipe 91 are controlled to be disconnected. That is, a drain valve 400 and a cutting fluid outlet valve 300 are controlled to be turned off. Thus, cleaning water does not flow into the cutting fluid output pipe 91, and further a possibility of mixing of the cleaning water and spraying of the cleaning water out of the spraying device 20 is reduced, such that cleanliness of the cutting fluid can be ensured. A cleaning liquid inlet pipe 126 is controlled to be turned on (a cleaning control valve 900 is turned on) until washing liquid fills the filter cartridge of a circulation system for cutting fluid, and then the cleaning liquid inlet pipe 126 is closed, thus ensuring that the filter cartridge is filled with water during washing. Ultrasonic operation is controlled with a working frequency range of 15 KHz≤f≤80 KHz, and the filter screen 56 is washed at a preset frequency.

Specific cleaning steps are as follows:
(1) a cutting fluid outlet valve 300 is turned off, and a drain valve 400 is turned off;
(2) an electromagnetic valve of a liquid path is turned on to fill a filter cartridge with water;
(3) the electromagnetic valve of the liquid path is turned off;
(4) an ultrasonic vibrating rod is controlled to work by an ultrasonic power supply, where an ultrasonic working frequency range satisfies 15 KHz≤f≤80 KHz, and working time satisfies 10 min≤t≤50 min;
(5) the drain valve 400 is turned on, and water left after cleaning of the filter cartridge is discharged into a liquid supply cylinder; and
(6) the drain valve 400 is turned off, such that cleaning is completed.

Specifically, the method further includes the following steps:
whether the operation duration of the ultrasonic cleaning assembly is longer than or equal to the second preset duration is determined, and if yes, a next step is executed; and
the cleaning liquid inlet pipe 7 and the drain pipe are controlled to be disconnected and connected respectively, and the cleaning liquid left after washing of the filter screen 2 is conveyed to a liquid supply device of the wire cutting machine.

The preset duration is set to satisfy 10 min≤t≤50 min. In some embodiments, the preset duration is 30 min.

Specific cleaning steps are as follows:
(1) a cutting fluid outlet valve is turned off, and a drain valve is turned off;
(2) an electromagnetic valve of a liquid path is turned on to fill a filter cartridge 1 with water;
(3) the electromagnetic valve of the liquid path is turned off;
(4) an ultrasonic vibrating rod is controlled to work by an ultrasonic power supply, where an ultrasonic working frequency range satisfies 15 KHz≤f≤80 KHz, and working time satisfies 10 min≤t≤50 min;
(5) the drain valve is turned on, and water left after cleaning of the filter cartridge 1 is discharged into a liquid supply cylinder; and
(6) the drain valve is turned off, such that cleaning is completed.

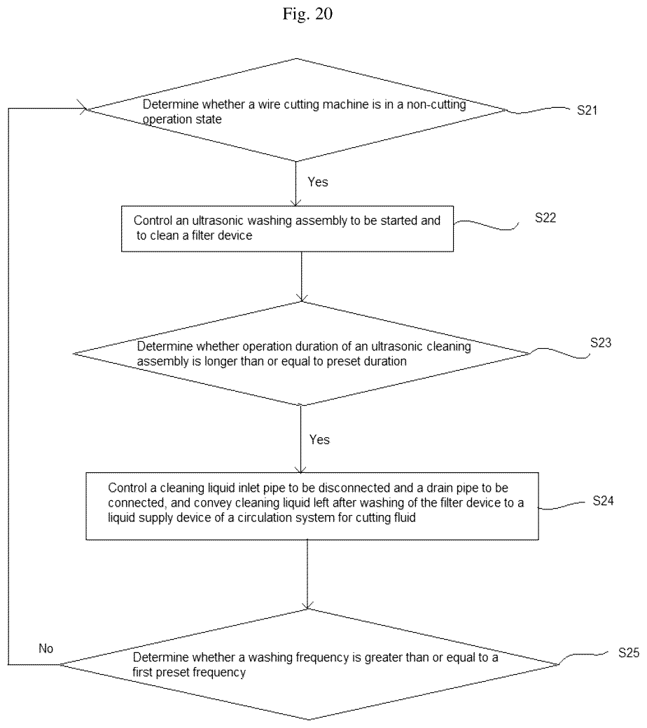

With reference to FIG. 20, FIG. 20 is a schematic flow diagram of a method for cleaning a filter device for cutting fluid according to some embodiments of the disclosure. The cleaning method includes the following steps:
S21, whether a wire cutting machine is in a non-cutting operation state is determined.
S22, in response to determining that the wire cutting machine is in the non-cutting operation state, an ultrasonic washing assembly is controlled to be started and to clean the filter device.

The non-cutting operation state indicates all states of the wire cutting machine other than a cutting operation state, which are all the non-cutting operation states. For instance, a state in which the wire cutting machine is turned on and then conducts no cutting operation and a feeding and discharging state in which a cutting device of the wire cutting machine suspends operation and materials are fed and discharged, are both included in the non-cutting operation states of the disclosure. In some embodiments, if the non-cutting operation state is the feeding and discharging state, the cutting device of the wire cutting machine is in an operation suspending state while a material feeding device conducts material feeding and discharging. In this way, the filter screen 56 is cleaned in an interval between two times of cutting operation, thus ensuring cutting operation efficiency and a cleaning effect of the filter screen. Meanwhile, the entire process is more compact.

S21 further includes the following step: in response to determining that the wire cutting machine is not in the non-cutting operation state, step one is repeated. That is, in response to determining that the wire cutting machine is in the non-cutting operation state, cleaning operation can be conducted, and otherwise, an operation state of the wire cutting machine needs to be re-determined.

In the example, the circulation system for cutting fluid further includes a drain pipe and a cutting fluid output pipe. The drain pipe and the cutting fluid output pipe are in communication with the filter device separately.

The cleaning method further includes, between S21 and S22, the following step:
The drain pipe and the cutting fluid output pipe 91 are controlled to be disconnected.

S22 specifically includes the following steps: washing liquid is injected into the filter device, and the ultrasonic washing assembly is controlled to operate to clean the filter device.

In response to determining that the wire cutting machine is in the non-cutting operation state, a drain pipe 92 and a cutting fluid output pipe 91 are controlled to be disconnected. That is, a drain valve 400 and a cutting fluid outlet valve 300 are controlled to be turned off. Thus, cleaning water does not flow into the cutting fluid output pipe 91, and further a possibility of mixing of the cleaning water and spraying of the cleaning water out of the spraying device 20 is reduced, such that cleanliness of the cutting fluid can be ensured. A cleaning liquid inlet pipe 126 is controlled to be turned on (a cleaning control valve 900 is turned on) until washing liquid fills the filter cartridge of a circulation system for cutting fluid, and then the cleaning liquid inlet pipe 126 is closed, thus ensuring that the filter cartridge is filled with water during washing. Ultrasonic operation is controlled with a working frequency range of 15 KHz≤f≤80 KHz, and the filter screen 56 is washed at a preset frequency.

A preset amount is a preset size, and is set according to a size of the filter cartridge, such that the ultrasonic washing assembly can achieve a desirable washing effect on the filter screen. In some embodiments, the cleaning liquid inlet pipe 126 is controlled to be turned on until the washing liquid fills the filter cartridge of the circulation system for cutting fluid.

The cleaning method further includes the following steps:
S23, whether operation duration of an ultrasonic cleaning assembly is longer than or equal to second preset duration is determined.
S24, in response to determining that the operation duration of the ultrasonic cleaning assembly is longer than or equal to the second preset duration, the cleaning liquid inlet pipe 126 and the drain pipe are controlled to be disconnected and connected respectively, and the cleaning liquid left after washing of the filter screen 56 is conveyed to a liquid supply device 10 of a circulation system for the cutting fluid.

In some embodiments, the preset duration is set to satisfy 10 min≤t≤50 min, and for instance, 30 min.

The cleaning method further includes the following step:
S25, whether a cleaning frequency of the ultrasonic cleaning assembly is greater than or equal to a first preset frequency is determined.

In response to determining that the cleaning frequency of the ultrasonic cleaning assembly is greater than or equal to the first preset frequency, the ultrasonic cleaning assembly is enabled to stop cleaning. Otherwise, S21-S24 are repeated.

The first preset frequency satisfies 1≤N≤10. In some embodiments, the first preset frequency is 5 times or 10 times.

Further, the method further includes, between S21 and S22, the following step:
Whether a cutting device of the wire cutting machine continuously conducts cutting for the preset cutting frequency is determined.

If yes, the wire cutting machine is controlled to change from the cutting operation state to the non-cutting operation state, and step two is executed. The preset frequency is 1 time-2 times. In some embodiments, the preset frequency is 1 time. Each time after the cutting device of the wire cutting machine cuts a material, the filter screen 56 is washed. As the cutting device stops cutting currently, the spraying device 20 does not need to spray the cutting fluid, and further the cutting fluid does not need to be filtered. In view of this, in the period, washing of the filter screen 56 is conducted to ensure the filter effect of the filter screen 56 and also make working procedures compact. In other embodiments, the preset frequency is set as 2 times or other times, which falls within the protection scope of the disclosure.

Specific cleaning steps are as follows:
(1) a cutting fluid outlet valve 300 is turned off, and a drain valve 400 is turned off;
(2) an electromagnetic valve of a liquid path is turned on to fill a filter cartridge with water;
(3) the electromagnetic valve of the liquid path is turned off;
(4) an ultrasonic vibrating rod is controlled to work by an ultrasonic power supply, where an ultrasonic working frequency range satisfies 15 KHz≤f≤80 KHz, and working time satisfies 10 min≤t≤50 min;
(5) the drain valve 400 is turned on, and water left after cleaning of the filter cartridge is discharged into a liquid supply cylinder; and
(6) the drain valve 400 is turned off, such that cleaning is completed.

It should be noted that the embodiments in the disclosure and features in the embodiments can be combined with one another if there is no conflict.

What are described above are merely preferred embodiments of the disclosure and are not intended to limit the disclosure, and various changes and modifications can be made to the disclosure by those skilled in the art. Any modifications, equivalent substitutions, improvements, etc. made within the spirit and principle of the disclosure should fall within the protection scope of the disclosure.

What is claimed is:

1. A filter device for cutting fluid, comprising:
a filter cartridge and a filter screen, wherein the filter screen is disposed in the filter cartridge, the filter screen is provided with a cutting fluid inlet and a drain outlet, the cutting fluid inlet is configured to allow to-be-filtered cutting fluid to flow into, the drain outlet is configured to discharge cleaning liquid and sewage in the filter screen, the filter cartridge is provided with a cutting fluid outlet, and the cutting fluid outlet is configured to discharge cutting fluid filtered; and
an ultrasonic cleaning assembly, wherein at least part of the ultrasonic cleaning assembly is disposed in the filter screen and configured to conduct ultrasonic cleaning on the filter screen.

2. The filter device as claimed in claim 1, wherein the filter cartridge comprises a cartridge body and a cartridge cover, and the cartridge cover covers a top of the cartridge body and is detachably connected with the cartridge body; a sealing ring is disposed between the cartridge body and the cartridge cover, and a fixing ring is disposed on an inner wall of the cartridge body in a circumferential direction; an outer wall of the filter screen is provided with a flange, and the filter screen is overlapped with the fixing ring by means of the flange; and a bottom of the filter screen is provided with a conical part, a top end of the conical part is provided with a mounting column, and the mounting column is provided with a through hole in communication with an inner cavity of the filter screen.

3. The filter device as claimed in claim 1, wherein the drain outlet is formed on a bottom of the filter screen, a mounting ring wall extending inward is disposed on the drain outlet in a circumferential direction, an outer side of the mounting ring wall is provided with a sealing ring mounting recess, a sealing ring is disposed in the sealing ring mounting recess, the mounting column is inserted into the mounting ring wall, and the sealing ring is disposed between the mounting column and the mounting ring wall.

4. The filter device as claimed in claim 2, wherein the ultrasonic cleaning assembly comprises an ultrasonic transducer and an ultrasonic amplitude transformer, one end of the ultrasonic transducer is detachably connected with the cartridge cover, an other end of the ultrasonic transducer is connected with the ultrasonic amplitude transformer, and one end of the ultrasonic amplitude transformer away from the ultrasonic transducer penetrates the cartridge cover and extends into the filter screen; and
a sealing gasket is disposed between the ultrasonic transducer and the cartridge cover; and
the filter cartridge further comprises a sealing pressure plate, and the sealing pressure plate is located on the ultrasonic transducer and fixed to the cartridge cover by means of a threaded fastener, so as to press the ultrasonic transducer and the cartridge cover tightly.

5. The filter device as claimed in claim 2, wherein the ultrasonic cleaning assembly comprises an ultrasonic vibrating rod and an ultrasonic vibrator, one end of the ultrasonic vibrating rod is detachably connected with the cartridge cover, the other end of the ultrasonic vibrating rod extends into the filter screen, and the ultrasonic vibrator is disposed in the ultrasonic vibrating rod and extends into the filter screen; and
a sealing gasket is disposed between the ultrasonic vibrating rod and the cartridge cover; a circumferential outer wall of the ultrasonic vibrating rod is provided with a flange part, a lower surface of the flange part is attached to an upper surface of the cartridge cover, and the flange part is fixed to the cartridge cover by means of a threaded fastener; and the flange part and the ultrasonic vibrating rod are integrally disposed.

6. The filter device as claimed in claim 1, further comprising a cleaning liquid inlet pipe, wherein one end of the cleaning liquid inlet pipe is in communication with the drain outlet, and the drain outlet is reused as a liquid inlet of the cleaning liquid inlet pipe; or,
the filter device further comprises a cleaning liquid inlet pipe, one end of the cleaning liquid inlet pipe is in communication with the cutting fluid outlet, and the cutting fluid outlet is reused as a liquid inlet of the cleaning liquid inlet pipe; or,
the filter device further comprises a cleaning liquid inlet pipe, the cleaning liquid inlet pipe is connected to a circumferential side wall of the filter cartridge, and a liquid inlet of the cleaning liquid inlet pipe is located at an outer side of the filter screen.

7. The filter device as claimed in claim 1, further comprising a cutting fluid input pipe and a pressure measurement assembly, wherein the cutting fluid input pipe is in communication with the cutting fluid inlet, and the pressure measurement assembly is disposed on the cutting fluid input pipe and configured to measure an internal pressure value of the filter cartridge.

8. The filter device as claimed in claim 1, further comprising:
a cutting fluid output pipe and a cutting fluid outlet valve, wherein the cutting fluid output pipe is in communication with the cutting fluid outlet, and the cutting fluid outlet valve is located at one end of the cutting fluid output pipe close to the cutting fluid outlet;
a drain pipe and a drain valve, wherein the drain pipe is in communication with the drain outlet, and the drain valve is located on the drain pipe and below the cleaning liquid inlet pipe; and
a cleaning control valve located on the cleaning liquid inlet pipe.

9. The filter device as claimed in claim 1, further comprising a cutting fluid output pipe and a flow measurement assembly, wherein the cutting fluid output pipe is in communication with the cutting fluid outlet, and the flow measurement assembly is disposed on the cutting fluid output pipe and configured to measure a cutting fluid output flow value of the filter cartridge.

10. A filter circulation system for cutting fluid, comprising:
a spraying device configured to spray the cutting fluid onto a workpiece cutting zone;
a liquid supply device configured to accommodate the cutting fluid and provide power for circulation of the cutting fluid;
a collecting device disposed on the liquid supply device and configured to collect the cutting fluid left after workpiece spraying and convey the cutting fluid to the liquid supply device;
a filter device connected between the spraying device and the liquid supply device and configured to filter the cutting fluid, wherein the filter device is the filter device as claimed in claim 1; and
a heat exchange device connected between the filter device and the spraying device and configured to cool the cutting fluid.

11. The filter circulation system as claimed in claim 10, wherein the liquid supply device is provided with a liquid supply pump and a liquid supply cylinder, and
a first end of the liquid supply pump is in communication with the liquid supply cylinder; and the filter circulation system further comprises a cutting fluid input pipe and a drain pipe, a first end of the cutting fluid input pipe is in communication with a second end of the liquid supply pump, a second end of the cutting fluid input pipe is in communication with the filter device, one end of the drain pipe is in communication with the filter device, and an other end of the drain pipe is in communication with the liquid supply device by means of a return pipe.

12. A cleaning method for a filter device for cutting fluid, wherein the filter device comprises a filter cartridge, a filter screen and an ultrasonic cleaning assembly, the filter screen is disposed in the filter cartridge, and at least part of the ultrasonic cleaning assembly is disposed in the filter screen and configured to conduct ultrasonic cleaning on the filter screen; and
the cleaning method comprises:
determining whether a wire cutting machine is in a cutting operation state; and
cleaning, in response to determining that the wire cutting machine is in the cutting operation state, the filter screen by the ultrasonic cleaning assembly.

13. The cleaning method as claimed in claim 12, wherein before cleaning the filter screen by the ultrasonic cleaning assembly, the cleaning method further comprises: determining whether an internal pressure value of the filter cartridge is greater than a first preset pressure value; and
executing, in response to determining that the internal pressure value of the filter cartridge is greater than the first preset pressure value, a step of the cleaning the filter screen by the ultrasonic cleaning assembly; and
the cleaning method further comprises:
determining whether the internal pressure value of the filter cartridge is smaller than a second preset pressure value, wherein the second preset pressure value is smaller than or equal to the first preset pressure value; and
enabling, in response to determining that the internal pressure value of the filter cartridge is smaller than the second preset pressure value, the ultrasonic cleaning assembly to stop cleaning the filter screen.

14. The cleaning method as claimed in claim 12, wherein before cleaning the filter screen by the ultrasonic cleaning assembly, the cleaning method further comprises:
determining whether a cutting fluid output flow value of the filter cartridge is smaller than a preset flow value; and
executing, in response to determining that the cutting fluid output flow value of the filter cartridge is smaller than the preset flow value, a step of the cleaning the filter screen by the ultrasonic cleaning assembly.

15. The cleaning method as claimed in claim 12, wherein after the determining that the wire cutting machine is in the cutting operation state, the cleaning method further comprises:
determining whether cutting operation duration of the wire cutting machine is longer than or equal to first preset duration; and
executing, in response to determining that the cutting operation duration of the wire cutting machine is longer than or equal to the first preset duration, a step of the cleaning the filter screen by the ultrasonic cleaning assembly.

16. The cleaning method as claimed in claim 12, wherein before the cleaning the filter screen by the ultrasonic cleaning assembly, the cleaning method further comprises:
determining whether a cutting frequency of the wire cutting machine is greater than or equal to a preset cutting frequency; and
executing, in response to determining that the cutting frequency of the wire cutting machine is greater than or equal to the preset cutting frequency, a step of the cleaning the filter screen by the ultrasonic cleaning assembly.

17. The cleaning method as claimed in claim 12, wherein cleaning the filter screen by the ultrasonic cleaning assembly comprises:
continuously cleaning the filter screen by the ultrasonic cleaning assembly; or,
cleaning the filter screen in a preset cleaning cycle by the ultrasonic cleaning assembly.

18. The cleaning method as claimed in claim 12, further comprising:
determining whether the wire cutting machine is in a non-cutting operation state; and
injecting, in response to determining that the wire cutting machine is in the non-cutting operation state, cleaning liquid into the filter cartridge, and cleaning the filter screen by the ultrasonic cleaning assembly.

19. The cleaning method as claimed in claim 18, further comprising:
determining whether operation duration of the ultrasonic cleaning assembly is longer than or equal to second preset duration; and
enabling, in response to determining that the operation duration of the ultrasonic cleaning assembly is longer than or equal to the second preset duration, the ultrasonic cleaning assembly to stop cleaning.

20. The cleaning method as claimed in claim 18, further comprising:
determining whether a cleaning frequency of the ultrasonic cleaning assembly is greater than or equal to a first preset frequency; and
enabling, in response to determining that the cleaning frequency of the ultrasonic cleaning assembly is greater than or equal to the first preset frequency, the ultrasonic cleaning assembly to stop cleaning.
